(19) United States
(12) Patent Application Publication
(10) Pub. No.: US 2026/0176134 A1
(43) Pub. Date: Jun. 25, 2026

(54) CONVERSION OF CO2 TO LIQUID PRODUCTS BY ELECTRIC-DRIVEN REFORMING

(71) Applicant: CHEVRON U.S.A. INC., San Ramon, CA (US)

(72) Inventor: Daniel CHINN, Danville, CA (US)

(73) Assignee: CHEVRON U.S.A. INC., San Ramon, CA (US)

(21) Appl. No.: 19/425,384

(22) Filed: Dec. 18, 2025

Related U.S. Application Data
(60) Provisional application No. 63/737,279, filed on Dec. 20, 2024.

(51) Int. Cl. C01B 3/34

(52) U.S. Cl. CPC C01B 3/34; C01B 2203/0205; C01B 2203/061; C01B 2203/1241

(57) ABSTRACT

Provided is a process of converting methane (CH₄) into syngas. The process comprises providing CH₄, CO₂, and H₂O to an electric-driven reformer to convert the feed of CH₄, CO₂, and H₂O to syngas. In one embodiment, the electric-driven reformer is an electric bi-reformer. The molar ratio of H₂O/CH₄ in the feed is generally in the range of from about 3 to 4, and the molar ratio of CH₄/CO₂ in the feed is in the range of from about 1 to 2.

### CROSS REFERENCE TO RELATED APPLICATION

This application claims priority to U.S. Provisional Patent Application No. 63/727,279 filed Dec. 20, 2024, the complete disclosure of which is incorporated herein by reference in its entirety.

### BACKGROUND

Processes for converting CO₂ to liquid products are known. The goal is to have a net conversion of CO₂ into liquid products by a suitable combination of reforming of the feedstock to syngas followed by syngas conversion to liquid products. The main feedstocks often comprise CH₄, H₂O, CO₂, and O₂ in various proportions, while syngas conversion can result in a variety of liquid products such as methanol, dimethyl ether (DME), diesel, butanal, etc. There are several challenges in developing a process that has a net CO₂ conversion, such as incomplete conversion of CO₂ in the reforming reaction and syngas conversion reactions, which are each often limited by equilibrium. Any combustion of carbon-containing fuel to generate heat or power to run the process emits direct CO₂ through the stack. Use of carbon-containing fuel also includes embedded, or indirect CO₂ through the production, processing, and transportation of the fuel to the point of use Also, import of electric power may have an indirect CO₂ footprint at well, depending on the grid intensity.

Tri-reforming reactions (reaction of CH₄ with O₂, H₂O, and CO₂ to syngas) have been tried, and some integrated with a steam electrolyzer. The electrolyzer is powered by renewable electricity, and provided with O₂ for reforming and supplemental H₂. The reformer can be run at a low steam/carbon ratio to ensure high CO₂ conversion but a H₂/CO ratio of under 2. One disadvantage of the tri-reforming approach is the high capital costs needed for the electrolyzer, and high operating costs due to the electric demand needed to drive it.

Therefore, the industry would welcome a process for reforming a feedstock to syngas that has a net CO₂ conversion, is electric-driven and provides a beneficial syngas for conversion to liquids products.

### SUMMARY

A summary of certain embodiments disclosed herein is sets forth below. It should be understood that these aspects are presented merely to provide the reader with a brief summary of these certain embodiments and that these aspects are note intended to limit the scope of this disclosure. Indeed, this disclosure may encompass a variety of aspects that may not be set forth below.

Provided is a process of converting methane (CH₄) into syngas, comprising providing CH₄, CO₂, and H₂O to an electric-driven reformer to convert the feed of CH₄, CO₂, and H₂O to syngas. In one embodiment, the electric-driven reformer is an electric bi-reformer. In one embodiment, the molar ratio of H₂O/CH₄ in the feed is in the range of from about 3 to 4 and the molar ratio of CH₄/CO₂ in the feed is in the range of from about 1 to 2.

Among other factors, it has been found that the present process achieves high methane conversion and net positive conversion of CO₂. The use of an electric bi-reformer process of reacting CH₄ with CO₂ and H₂O to produce syngas enables such results. Moreover, the present process can produce a syngas with a H₂/CO ratio that is beneficial for further conversion to liquid products such as methanol, DME, diesel, butanal and others.

### BRIEF DESCRIPTION OF THE DRAWINGS

FIG. 1 schematically depicts using an electric bi-reformer process to prepare syngas which is then converted to liquid products.

FIG. 2 graphically depicts the net conversion of CO₂ as a function of grid intensity.

FIG. 3 graphically depicts CH₄ and CO₂ conversion for an electric-driven reformer.

FIG. 4 depicts H₂/CO in syngas product from an electric-driven reformer.

FIG. 5 graphically depicts CO₂ generation/consumption from an electric-driven reformer.

FIG. 6 graphically depicts the energy consumption for an electric-driven reformer.

### DETAILED DESCRIPTION

The present process utilizes an electric-driven reformer to convert CH₄, CO₂, and H₂O into syngas. Syngas is a gas mixture containing varying amounts of CO and H₂. The electricity provides the energy to overcome the endothermic heat of reaction. In one embodiment, the outlet temperature is maintained at about ˜950° C. and the pressure is maintained at about 20 to 40 bar. The syngas H₂/CO ratio is targeted to about 2 by controlling the feed H₂O/CH₄ ratio and % CO₂.

The electric-driven reformer can be any suitable reformer reactor, as are known. The reformer comprises a catalyst to catalyze the reaction to produce syngas. The reformer can be a tube-like structure with catalyst on its insides. Examples of suitable catalyst include, but are not limited to, the following:
1. Nickel on ICR953 alumina, citric acid
2. Ni on Ca/Mg oxide-superior micropowder, CaO:MgO=80:20
3. Ni on sulfated zirconia
4. Sulfated ZrO₂ impregnated with 7% wt. La+5% Ni
5. Ni/W on alumina, 10% wt Ni through second impregnation
6. Ceria impregnated with 7% wt. La+5% Ni.

The reformer provides electric heat, inductive heating, for the reaction. This is a benefit in reducing CO or CO₂ production during the heating process. There is no stack or exhaust. The outlet temperature of the reformer is generally maintained in the range of from 925 to 975° C., and generally about 950° C. The pressure at the outlet is generally maintained in the range of from 20 to 40 bar.

The electric-driven reformer is in one embodiment a bi-reformer, in that methane (CH₄) is reacted only with CO₂ and H₂O. No O₂ is used in the reaction. The bi-reformer has been found to provide the highest net CO₂ conversion.

As discussed above, the syngas H₂/CO ratio is targeted to be about 2. The H₂/CO ratio of the syngas product can range from 1.6 to 3 in one embodiment. In another embodiment, the H₂/CO ratio can range from about 1.7 to 2.5, or 1.7 to 2.3. A ratio of about 2 is the target. For when the ratio is closest to 2, benefits in the syngas to liquid products reaction are observed. When the ratio of the syngas is much higher than 2, a surplus of H₂ is in the syngas, which has been found to be detrimental to subsequently making liquid products from the syngas. When the ratio is much lower than 2, the syngas has been found to be starved of H₂, with a surplus of CO, often resulting in only aldehyde liquid products. When the ratio is about 2, a wide range of liquid petroleum products can be obtained. Thus, controlling the conversion of methane to produce a syngas having a H₂/CO ratio of about 2, e.g., in the range of 1.6 to 3, or 1.7 to 2.3, offers great benefits in CO₂ conversion, but also in the subsequent conversion of the syngas to liquid products. Of particular interest is the conversion to methanol as a primary liquid of interest. Using a syngas having a H₂/CO ratio of about 2 has been found quite effective in this regard.

In order to control the present process to prepare such a syngas with a ratio of about 2, the inlet feed ratio of H₂O/CH₄ and percentage of CO₂ in the feed is controlled. In one embodiment, the molar ratio of H₂O/CH₄ in the fed is in the range of from 3 to 4, with the molar ratio of CH₄/CO₂ in the feed in the range of from about 1 to 2.

For example, based on a feed ratio of CH₄:CO₂: H₂O of 1:1.25:3.5, the equilibrium conversion of CH₄ is 98% while that for CO₂ is 25%. The H₂/CO ratio in the syngas is 2. The inlet conditions are 825° C., 23.5 bar while the outlet is maintained at 950° C., 22.5 bar.

Generally, the inlet conditions can include a temperature in the range of from 800 to 1000° C., and in one embodiment about 825° C. The pressure can be in the range 20 to 30 bar, and in one embodiment, about 23.5 bar. The result is a syngas prepared with a net CO₂ conversion, using an electric-driven reformer and all of its benefits, and with a syngas having a beneficial ratio of H₂/CO for producing liquid products such as methanol.

An electric bi-reformer can be coupled with a methanol synthesis plant. Employing the present process of preparing syngas allows for effective conversion in the methanol synthesis plant.

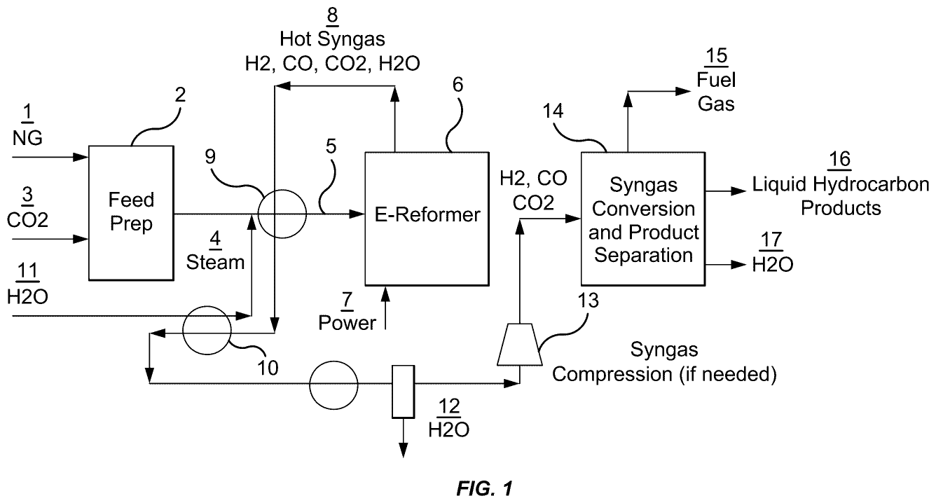

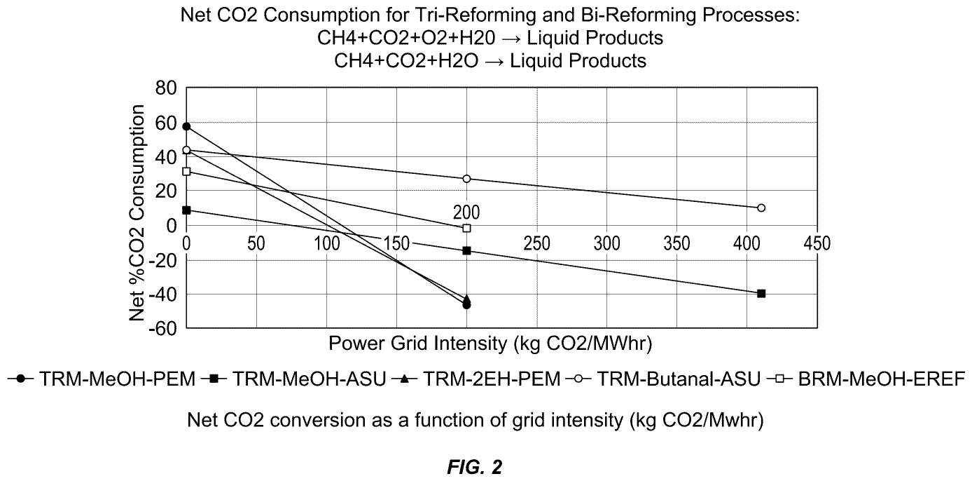

FIG. 1 schematically depicts using an electric bi-reformer to prepare syngas, which is then converted to liquid products. The two processes are integrated in FIG. 2.

Natural gas, or CH₄, 1, is passed to a feed preparation unit 2 along with CO₂ 3. Water, or steam 4, is combined with the CH₄ and CO₂ and then passed via 5 to an electric reformer 6. Electric power 7 is provided to the reformer 6. Hot syngas is removed from the reformer at 8 and passed optionally through a heat exchanger 9, which can heat the feed to the electric reformer, and optionally through heat exchanger 10, which can heat water 11 to steam 4. Water can be removed from the syngas at 12.

The hot syngas can then be compressed at 13, if desired or needed. The syngas is then passed into a syngas conversion reactor 14. Fuel gas 15, liquid hydrocarbon products 16 and water 17 are then separated and removed/collected from the syngas conversion unit 14. As discussed above, using the present syngas process allows for beneficial results in producing liquid hydrocarbon products.

TABLE 1

| | MeOH | MeOH | MeOH |
|---|---|---|---|
| | with PEM | with PEM | with PEM |
| | Electrolyzer | Electrolyzer | Electrolyzer |
| | PEM-TRM-No- | PEM-TRM-No- | 80% Green |
| Description | PreRef-MeOH- | PreRef-MeOH- | Power |
| Supplemental Green H2? | Yes | Yes | Yes |
| Electricity Grid | Green | Hybrid | |
| Input (kgmole/hr) | | | |
| CH4 | 1465 | 1465 | 1465 |
| CO2 | 732.5 | 732.5 | 732.5 |
| H2O | 2900 | 2900 | 2900 |
| O2 | 0 | 0 | 0 |
| Propylene | 0 | 0 | 0 |
| Output | | | |
| MeOH (bpd) | 11390 | 11390 | 11390 |
| 2-EH (bpd) | 0 | 0 | 0 |
| i-butanal (bpd) | 0 | 0 | 0 |
| n-butanal (bpd) | 0 | 0 | 0 |
| wastewater (bpd) | 5341 | 5341 | 5341 |
| Tail gas to fuel (kgmole/hr) | 285.4 | 285.4 | 285.4 |
| Total Heating Demand (kw) | 464 | 464 | 464 |
| NG compresion (kW) | 5208 | 5208 | 5208 |
| CO2 compression (kW) | 2572 | 2572 | 2572 |
| O2 Compression (kW) | | | |
| H2O Pump (kW) | 44 | 44 | 44 |
| ASU Power (kW) | 0 | | |
| Electrolyzer/E-Reformer (kW) | 150,300 | 150,300 | 150,300 |
| Syngas Compression (kW) | 9130 | 9,130 | 9,130 |
| Total Power Demand (kw) | 167254 | 167,254 | 167,254 |
| CO2 from heating (kgmole/hr) | 2.13 | 2.13 | 2.13 |
| CO2 from power (kgmole/hr) | 0.00 | 760.25 | 380.12 |
| CO2 conv from Reformer | 150.00 | 150.00 | 150.00 |
| (kgmole/hr) | | | |
| CO2 conv Synthesis (kgmole/hr) | 326.00 | 326.00 | 326.00 |
| Tail Gas (non CO2) kgmole/hr | 54.00 | 54.00 | 54.00 |
| CO2 Emitted (kgmole/hr) | 312.63 | 1072.88 | 692.75 |
| CO2 Consumed (kgmole/hr) | 419.87 | −340.38 | 39.75 |
| Net CO2 Consumed (tonne/yr) | 161,835 | −131,194 | 15,320 |
| Net CO2 Consumed (tpd) | 443 | −359 | 42 |
| Net CO2 consumed as % of Feed | 57.32 | −46.47 | 5.43 |
| Wet Syngas leaving refomer (kg/h) | 1.02E+05 | 1.02E+05 | 1.02E+05 |
| Net Co2 consumed (kg/h) | 18474.27 | −14976.53 | 1748.87 |
| Net CO2 consumed per Wet Syngas | 0.18 | −0.15 | 0.02 |
| made (kg/kg) | | | |
| Net CO2 Consumed per Liquid | 38.93 | −31.56 | 3.69 |
| Product Made (kg/bbl) | | | |

TABLE 2

| | MeOH with ASU | MeOH with ASU | MeOH with ASU |
|---|---|---|---|
| | TriReformer- | TriReformer- | TriReformer- |
| Description | MeOH- | MeOH- | MeOH- |
| Supplemental Green H2? | No | No | No |
| Electricity Grid | Grid | Hybrid | Green |
| Input (kgmole/hr) | | | |
| CH4 | 2191 | 2191 | 2191 |
| CO2 | 827 | 827 | 827 |
| H2O | 2100 | 2100 | 2100 |
| O2 | 1100 | 1100 | 1100 |
| Propylene | 0 | 0 | 0 |
| Output | | | |
| MeOH (bpd) | 12060 | 12060 | 12060 |
| 2-EH (bpd) | 0 | 0 | 0 |
| i-butanal (bpd) | 0 | 0 | 0 |
| n-butanal (bpd) | 0 | 0 | 0 |
| wastewater (bpd) | 6416 | 6416 | 6416 |
| Tail gas to fuel (kgmole/hr) | 451.9 | 451.9 | 451.9 |
| Total Heating Demand (kw) | 0 | 0 | 0 |
| NG compresion (kW) | 7944 | 7944 | 7944 |
| CO2 compression (kW) | 2940 | 2940 | 2940 |
| O2 Compression (kW) | | | |
| H2O Pump (kW) | 34 | 34 | 34 |
| ASU Power (kW) | 21290 | 21290 | 21290 |
| Electrolyzer/E-Reformer (kW) | 0 | 0 | 0 |
| Syngas Compression (kW) | 10,680 | 10680 | 10,680 |
| Total Power Demand (kw) | 42,888 | 42,888 | 42,888 |
| CO2 from heating (kgmole/hr) | 0.00 | 0.00 | 0.00 |
| CO2 from power (kgmole/hr) | 399.64 | 194.95 | 0.00 |
| CO2 conv from Reformer | 89.00 | | 89.00 |
| (kgmole/hr) | | | |
| CO2 conv Synthesis (kgmole/hr) | 40.00 | | 40.00 |
| Tail Gas (non CO2) kgmole/hr | 54.90 | | 54.90 |
| CO2 Emitted (kgmole/hr) | 1152.54 | 1021.95 | 752.90 |
| CO2 Consumed (kgmole/hr) | −325.54 | −194.95 | 74.10 |
| Net CO2 Consumed (tonne/yr) | −125,475 | −75,140 | 28,561 |
| Net CO2 Consumed (tpd) | −344 | −206 | 78 |
| Net CO2 consumed as % of Feed | −39.36 | −23.57 | 8.96 |
| Wet Syngas leaving refomer | 1.02E+05 | 1.02E+05 | 1.02E+05 |
| (kg/h) | | | |
| Net Co2 consumed (kg/h) | −14323.68 | −8577.60 | 3260.40 |
| Net CO2 consumed per Wet | −0.14 | −0.08 | 0.03 |
| Syngas made (kg/kg) | | | |
| Net CO2 Consumed per Liquid | −28.50 | −17.07 | 6.49 |
| Product Made (kg/bbl) | | | |

TABLE 3

| | | | 2-Ethylhexanol |
|---|---|---|---|
| | MeOH by Bi- | MeOH by Bi- | with PEM |
| | Reforming with | Reforming with | Electrolyzer |
| | E-Reformer | E-Reformer | TRM- |
| | BRM-MeOH- | BRM-MeOH- | Hydroformyl- |
| Description | Electric- | Electric- | PEM- |
| Supplemental Green H2? | No | No | Yes |
| Electricity Grid | Green | Hybrid | Green |
| Input (kgmole/hr) | | | |
| CH4 | 1447 | 1447 | 150 |
| CO2 | 1000 | 1000 | 100 |
| H2O | 7000 | 7000 | 220 |
| O2 | 0 | 0 | 0 |
| Propylene | 0 | 0 | 205 |
| Output | | | |
| MeOH (bpd) | 1.14E+04 | 11390 | 0 |
| 2-EH (bpd) | 0 | 0 | 1935 |
| i-butanal (bpd) | 0 | 0 | 537 |
| n-butanal (bpd) | 0 | 0 | 0 |
| wastewater (bpd) | 1.67E+04 | 16730 | 561 |
| Tail gas to fuel (kgmole/hr) | 90.06 | 90.06 | 68.8 |
| Total Heating Demand (kw) | 0.00E+00 | 0 | 0 |
| NG compresion (kW) | 5246 | 5246 | 582 |
| CO2 compression (kW) | 5252 | 5252 | 379 |
| O2 Compression (kW) | 0 | 0 | |
| H2O Pump (kW) | 114 | 114 | 4.4 |
| ASU Power (kW) | 0 | 0 | 0 |
| Electrolyzer/E-Reformer (kW) | 111,000 | 111000 | 17120 |
| Syngas Compression (kW) | 10,095 | 10095 | 1,013 |
| Total Power Demand (kw) | 131,707 | 131,707 | 19,098 |
| CO2 from heating (kgmole/hr) | 0.00 | 0.00 | 0.00 |
| CO2 from power (kgmole/hr) | 0.00 | 598.67 | 0.00 |
| CO2 conv from Reformer | 214.00 | 214.00 | 61.00 |
| (kgmole/hr) | | | |
| CO2 conv Synthesis (kgmole/hr) | 340.30 | 340.30 | 0.00 |
| Tail Gas (non CO2) kgmole/hr | 3.00 | 3.00 | 17.10 |
| CO2 Emitted (kgmole/hr) | 448.70 | 1047.37 | 56.10 |
| CO2 Consumed (kgmole/hr) | 551.30 | −47.37 | 43.90 |
| Net CO2 Consumed (tonne/yr) | 212,493 | −18,258 | 16,921 |
| Net CO2 Consumed (tpd) | 582 | −50 | 46 |
| Net CO2 consumed as % of Feed | 55.13 | −4.74 | 43.90 |
| Wet Syngas leaving refomer (kg/h) | 2.24E+05 | 1.93E+05 | 9702 |
| Net Co2 consumed (kg/h) | 24257.20 | −2084.20 | 1931.60 |
| Net CO2 consumed per Wet Syngas | 0.11 | −0.01 | 0.20 |
| made (kg/kg) | | | |
| Net CO2 Consumed per Liquid | 51.11 | −4.39 | 18.75 |
| Product Made (kg/bbl) | | | |

TABLE 4

| | 2-Ethylhexanol | |
|---|---|---|
| | with PEM | |
| | Electrolyzer | Butanal with |
| | TRM- | ASU |
| | Hydroformyl- | TRM- |
| Description | PEM- | Hydroformyl- |
| Supplemental Green H2? | Yes | No |
| Electricity Grid | Hybrid | Grid |
| Input (kgmole/hr) | | |
| CH4 | 150 | 150 |
| CO2 | 100 | 100 |
| H2O | 220 | 15 |
| O2 | 0 | 82 |
| Propylene | 205 | 205 |
| Output | | |
| MeOH (bpd) | 0 | 0 |
| 2-EH (bpd) | 1935 | 0 |
| i-butanal (bpd) | 537 | 537 |
| n-butanal (bpd) | 0 | 2203 |
| wastewater (bpd) | 561 | 242 |
| Tail gas to fuel (kgmole/hr) | 68.8 | 67 |
| Total Heating Demand (kw) | 0 | 0 |
| NG compresion (kW) | 582 | 582 |
| CO2 compression (kW) | 379 | 379 |
| O2 Compression (kW) | | |
| H2O Pump (kW) | 4.4 | 0.3 |
| ASU Power (kW) | 0 | 1583 |
| Electrolyzer/E-Reformer (kW) | 17120 | 0 |
| Syngas Compression (kW) | 1,013 | 1,020 |
| Total Power Demand (kw) | 19,098 | 3,564 |
| CO2 from heating (kgmole/hr) | 0.00 | 0.00 |
| CO2 from power (kgmole/hr) | 86.81 | 33.21 |
| CO2 conv from Reformer | 61.00 | 60.60 |
| (kgmole/hr) | | |
| CO2 conv Synthesis (kgmole/hr) | 0.00 | 0.00 |
| Tail Gas (non CO2) kgmole/hr | 17.10 | 17.20 |
| CO2 Emitted (kgmole/hr) | 142.91 | 89.81 |
| CO2 Consumed (kgmole/hr) | −42.91 | 10.19 |
| Net CO2 Consumed (tonne/yr) | −16,540 | 3,927 |
| Net CO2 Consumed (tpd) | −45 | 11 |
| Net CO2 consumed as % of Feed | −42.91 | 10.19 |
| Wet Syngas leaving refomer (kg/h) | 9702 | 9702 |
| Net Co2 consumed (kg/h) | −1888.08 | 448.24 |
| Net CO2 consumed per Wet Syngas | −0.19 | 0.05 |
| made (kg/kg) | | |
| Net CO2 Consumed per Liquid | −18.33 | 3.93 |
| Product Made (kg/bbl) | | |

TABLE 5

| | Butanal with | Butanal with |
|---|---|---|
| | ASU | ASU |
| | TRM- | TRM- |
| Description | Hydroformyl- | Hydroformyl- |
| Supplemental Green H2? | No | No |
| Electricity Grid | Hybrid | Green |
| Input (kgmole/hr) | | |
| CH4 | 150 | 150 |
| CO2 | 100 | 100 |
| H2O | 15 | 15 |
| O2 | 90 | 82 |
| Propylene | 205 | 205 |
| Output | | |
| MeOH (bpd) | 0 | 0 |
| 2-EH (bpd) | 0 | 0 |
| i-butanal (bpd) | 537 | 537 |
| n-butanal (bpd) | 2203 | 2203 |
| wastewater (bpd) | 242 | 242 |
| Tail gas to fuel (kgmole/hr) | 67 | 67 |
| Total Heating Demand (kw) | 0 | 0 |
| NG compresion (kW) | 582 | 582 |
| CO2 compression (kW) | 379 | 379 |
| O2 Compression (kW) | | |
| H2O Pump (kW) | 0.3 | 0.3 |
| ASU Power (kW) | 1583 | 1583 |
| Electrolyzer/E-Reformer (kW) | 0 | 0 |
| Syngas Compression (kW) | 1,020 | 1,020 |
| Total Power Demand (kw) | 3,564 | 3,564 |
| CO2 from heating (kgmole/hr) | 0.00 | 0.00 |
| CO2 from power (kgmole/hr) | 16.20 | 0.00 |
| CO2 conv from Reformer | 60.60 | 60.60 |
| (kgmole/hr) | | |
| CO2 conv Synthesis (kgmole/hr) | 0.00 | 0.00 |
| Tail Gas (non CO2) kgmole/hr | 17.20 | 17.20 |
| CO2 Emitted (kgmole/hr) | 72.80 | 56.60 |
| CO2 Consumed (kgmole/hr) | 27.20 | 43.40 |
| Net CO2 Consumed (tonne/yr) | 10,483 | 16,728 |
| Net CO2 Consumed (tpd) | 29 | 46 |
| Net CO2 consumed as % of Feed | 27.20 | 43.40 |
| Wet Syngas leaving refomer (kg/h) | 9702 | 9702 |
| Net Co2 consumed (kg/h) | 1196.74 | 1909.60 |
| Net CO2 consumed per Wet Syngas | 0.12 | 0.20 |
| made (kg/kg) | | |
| Net CO2 Consumed per Liquid | 10.48 | 16.73 |
| Product Made (kg/bbl) | | |

Tables 1-5 summarize the material and energy balances for several scenarios comparing a bi-reforming process with a tri-reforming process. Bi-reforming exhibits the highest net CO₂ conversion compared to tri-reforming. In the Tables, PEM refers to Proton Exchange Membrane electrolyzer.

FIG. 2 graphically shows a summary of net CO₂ conversion to either methanol or butanal as a function of the power grid density. For methanol conversion, bi-reforming is the only process with the highest net CO₂ conversion at a grid intensity of 100 kg CO₂/Mw hr, while at 200 kg CO₂/Mw hr, the bi-reforming process is CO₂-neutral while the analogous tri-reforming processes to methanol all have a net CO₂ emissions.

The present process is advantageous and useful for the following circumstances:
1. The available power grid is 100 kg CO₂/MW hr or less;
2. It is desired to avoid the investment of a steam electrolyzer;
3. It is desired to avoid the safety issues of handling pure O₂ at high temperature and pressures; and
4. Methanol is the primary liquid of interest and can be produced most effectively.

Thus, the present process offers an energy efficient, green method of converting methane into syngas. The process uses an electric-driven bi-reformer, which allows one to achieve a net positive CO₂ conversion while also producing a syngas with a H₂/CO ratio beneficial for subsequent liquid hydrocarbon production. By controlling the H₂O/CH₄ ratio in the feed and the percentage of CO₂ in the feed, a syngas that allows production of wide range of useful liquid hydrocarbon products, such as methanol, is achieved. Integrating the syngas production with a liquid hydrocarbon synthesis plant would therefore be of great value to the industry.

The following example is provided to further illustrate the present processes. The example is not meant to be limiting.

### Example

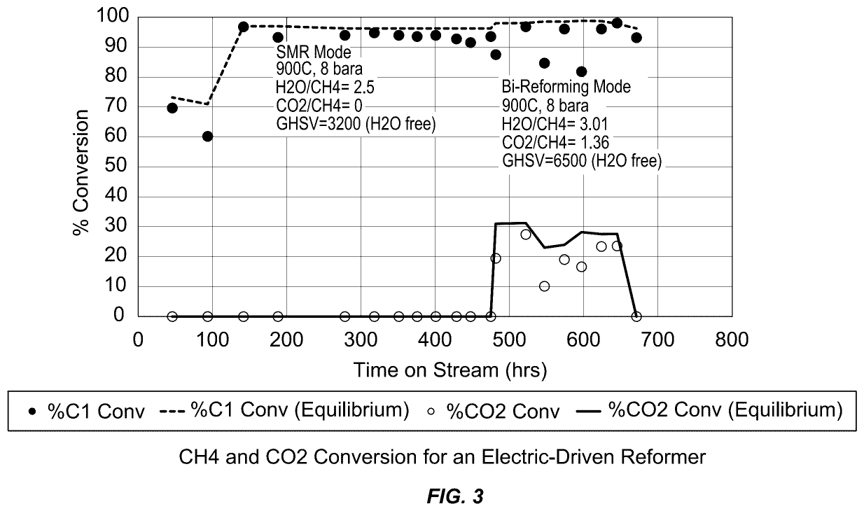

A lab-scale, electric-driven reformer comprises alumina tubular reactors coated with 3 to 4 wt. % of calcined Ni on ICR153 alumina, citric acid. The tubular reactors are in close proximity to resistive electric heaters which heat the flowing gas to the desired reactor temperature. The electric heat input varies from 200 to 350 W. The entire reactor and heater assembly are packaged into a pressure vessel capable of up to 8 bar operation. A mixture of CH₄, H₂O, and CO₂ are feed to the unit at a fixed inlet temperature, pressure and operation while the outlet flowrate and composition is continuously monitored. The electric duty input is set to maintain a constant outlet temperature of 900° C. FIGS. 3-6 show the results.

FIG. 3 shows the methane and CO₂ conversion as the feed conditions are switched from steam methane reforming (SMR) mode where CH₄ and H₂O are fed to bi-reforming mode, where CH₄, H₂O, and CO₂ are fed. Methane conversion for both modes is over 95%, while in bi-reforming mode the CO₂ conversion is as high as 30%.

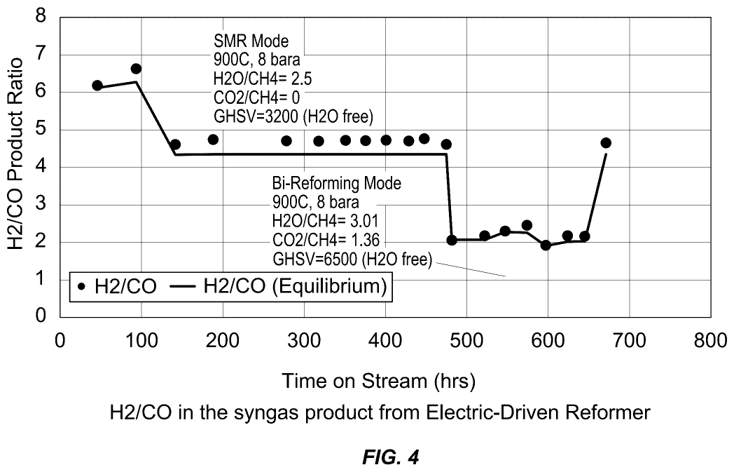

FIG. 4 shows the H₂/CO product ratio in the reactor effluent as a function of time. Initially, under SMR mode, the H₂/CO ratio exceeds 4, which is desirable for hydrogen production. In the case of syngas production for methanol synthesis, the bi-reforming mode results in a H₂/CO ratio of 2 which is more desirable. In order to ensure that the catalyst is stable, the final experiment is to restore the test conditions back to SMR mode. As shown in FIG. 4, the H₂/CO ratio of 4 is restored.

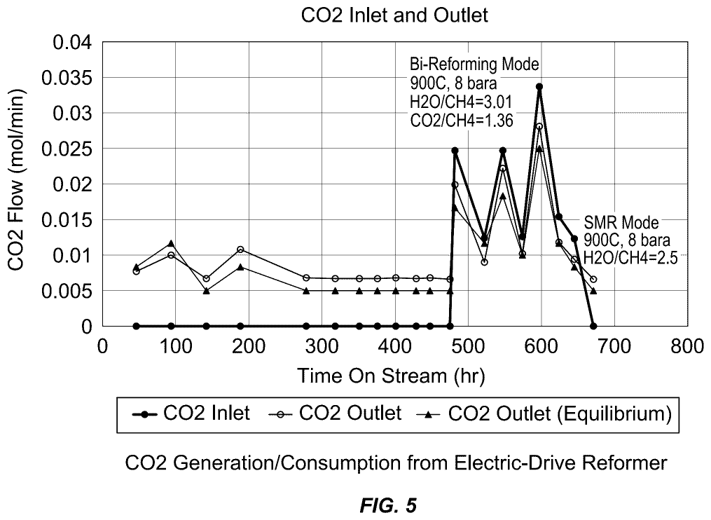

FIG. 5 plots the CO₂ flow over time. In SMR mode, CO₂ is actually generated by the water gas shift (WGS) reactions in steam reforming. When the test is switched to bi-reforming mode, the CO₂ in the outlet gas is consistently lower than that of the inlet, which means that there is a net consumption of CO₂.

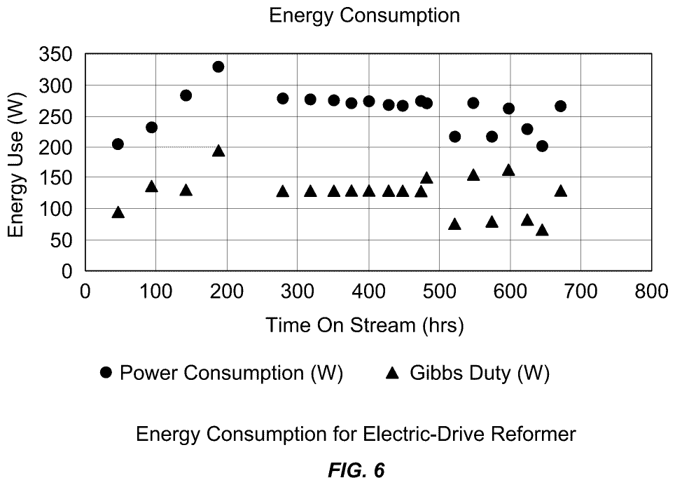

FIG. 6 shows the energy consumption over time for the electrified reformer. The total consumption ranged from 200 to 350 W. Also shown for comparison is the theoretical energy consumption based on 100% equilibrium according to minimization of the Gibbs Free Energy change for the specific condition. Not surprisingly, the actual energy input exceeds the theoretical energy input due to various inefficiencies such as heat losses.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements except for only minor traces of impurities.

As those skilled in the art will appreciate, numerous modifications and variations of the present invention are possible considering these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A process of converting methane (CH₄) into syngas, comprising:
providing CH₄, CO₂, and H₂O to an electric-driven reformer to convert the feed of CH₄, CO₂, and H₂O to syngas.

2. The process of claim 1, wherein the electric-driven reformer is an electric bi-reformer.

3. The process of claim 2, wherein the molar ratio of H₂O/CH₄ in the feed is in the range of from about 3 to 4 and the molar ratio of CH₄/CO₂ in the feed is in the range of from about 1 to 2.

4. The process of claim 3, wherein the molar ratio of H₂/CO in the syngas obtained is in the range of from about 1.6 to 3.

5. The process of claim 4, wherein the molar ratio of H₂/CO in the syngas obtained is in the range of from about 1.7 to 2.5.

6. The process of claim 4, wherein the molar ratio of H₂/CO in the syngas obtained is in the range of from about 1.7 to 2.3.

7. The process of claim 4, wherein the molar ratio of H₂/CO in the syngas obtained is about 2.

8. The process of claim 1, wherein the equilibrium conversion of CH₄ is in the range of from about 90 to 99%.

9. The process of claim 8, wherein the conversion of CH₄ is in the range of about 95 to 99%.

10. The process of claim 8, wherein the conversion of CH₄ is in the range of about 98%.

11. The process of claim 3, wherein the equilibrium conversion of CO₂ is in the range of from about 10 to 30%.

12. The process of claim 11, wherein the conversion of CO₂ is in the range of from about 10 to 25%.

13. The process of claim 11, wherein the conversion of CO₂ is about 25%.

14. A process for preparing liquid products from syngas, which process comprises:
preparing syngas by the process of claim 3, and then
providing the syngas to a synthesis plant to prepare liquid products from the syngas.

15. The process of claim 14, wherein the synthesis plant is a methanol synthesis plant.

16. The process of claim 14, wherein the syngas has a molar ratio of H₂/CO in the range of from 1.6 to 3.

17. The process of claim 14, wherein the molar ratio of H₂/CO in the syngas obtained is in the range of from about 1.7 to 2.5.

18. The process of claim 14, wherein the molar ratio of H₂/CO in the syngas obtained is in the range of from about 1.7 to 2.3.

19. The process of claim 14, wherein the molar ratio of H₂/CO in the syngas obtained is about 2.

20. The process of claim 14, wherein methanol is recovered from the synthesis plant.
